(19) United States
(12) Patent Application Publication
(10) Pub. No.: US 2021/0321828 A1
(43) Pub. Date: Oct. 21, 2021

(54) LOCKING ASSEMBLY FOR A REMOVABLE HANDLE

(71) Applicant: HY CITE ENTERPRISES, LLC, Madison, WI (US)

(72) Inventors: Craig Stevenson, Fitchburg, WI (US); Aric Dichraff, Madison, WI (US); Lu Shen, Johnson Creek, WI (US); Ana E. Pineiro, Madison, WI (US); Julio Angel Salva Alvarez, Madison, WI (US); Morad Ghassemian, Oak Park, IL (US); Brian Lee, Chicago, IL (US); Yan Shang Xin, Guangdong (CN); Ou Guan Xun, Guangdong (CN); Liang Yujun, Guangdong (CN); Ko Chor Leung, Hong Kong (CN); Chan Chi Wai, Hong Kong (CN)

(21) Appl. No.: 16/849,939

(22) Filed: Apr. 15, 2020

(51) Int. Cl. A47J 45/07

(52) U.S. Cl. CPC A47J 45/07

(57) ABSTRACT

A detachable handle assembly for an item of cookware includes a handle configured to removably engage a mounting member coupled to the item of cookware, and a locking assembly slidably received in a slot defined by the handle. The locking assembly includes a housing defining an aperture and a button, a biasing member configured to apply a biasing force on the housing, and a locking surface positions on a circumferential surface that defines the aperture, wherein the mounting member is configured to be received by the aperture and selectively engage the locking surface.

### FIELD OF THE INVENTION

The present invention relates to a selectively removable handle for a pot, pan, or other item of cookware. More specifically, the present invention relates to a locking assembly that is configured to selectively lock the removable handle to the item of cookware.

### BACKGROUND

Cookware with a non-removable handle is generally known in the art. A handle provides a user with a convenient way to carry, hold, or otherwise move the cookware. Unfortunately, such cookware has limitations. For example, the non-removable handle extends a distance away from the cookware, taking up a substantial amount of storage space (e.g., kitchen cabinets, etc.) and/or area of use (e.g., stove tops, ovens, etc.). In addition, cookware with non-removable handles has limitations as to the material that can be used to form the handle. For example, some non-removable handles are formed of a metallic material to allow for use on a stovetop and in an oven. However, when this cookware is heated, the non-removable handle also becomes hot. This hot handle can lead to burns on a user's hand. To attempt to address this hot handle issue, other cookware forms the non-removable handle out of a material that limits heat transfer from the cookware to the handle (e.g., a polymer, etc.). Unfortunately, this handle material can have a lower melting temperature, meaning the cookware cannot be used in an oven or in certain high temperature environments.

Other cookware attempts to address these issues by providing a removable handle. Unfortunately, these known removable handles do not include any lock, which can lead to unintentional detachment of the handle from the cookware. Unintentional detachment can cause undesirable results, including food waste and user injury. For example, unintentional detachment of the handle while the user carries cookware that contains hot food can lead to user injury (e.g., burns, etc.) and food waste (e.g., due to spilling of the food). Accordingly, there is a need for cookware that can provide a removable handle for cookware that includes a reliable, yet simple way to lock the handle to the cookware to avoid unintentional handle detachment.

### SUMMARY

In one embodiment, the disclosure provides a detachable handle assembly for an item of cookware includes a handle configured to removably engage a mounting member coupled to the item of cookware, and a locking assembly slidably received in a slot defined by the handle. The locking assembly includes a housing defining an aperture and a button, a biasing member configured to apply a biasing force on the housing, and a locking surface positions on a circumferential surface that defines the aperture, wherein the mounting member is configured to be received by the aperture and selectively engage the locking surface.

Other aspects of the invention will become apparent by consideration of the detailed description and accompanying drawings.

### BRIEF DESCRIPTION OF THE DRAWINGS

FIG. 1 is a perspective view of an embodiment of an item of cookware that includes a plurality of removable handles in an attached configuration.

FIG. 2 is a first perspective view of a mounting member detached from the item of cookware shown in FIG. 1 illustrating a handle connection member.

FIG. 3 is a side view of the mounting member of FIG. 2.

FIG. 4 is a second perspective view of the mounting member of FIG. 2 illustrating an item of cookware connection portion.

FIG. 5 is a perspective view of a removable handle engaged with the mounting member of FIG. 2, the mounting member being detached from the item of cookware.

FIG. 6 is a partially exploded view of the handle of FIG. 5 illustrating a locking assembly.

FIG. 7 is a perspective view of a first side of a locking member of the locking assembly of FIG. 6, the first side receiving the mounting member.

FIG. 8 is a perspective view of a second, opposite side of the locking member of FIG. 7.

FIG. 9 is a cross-sectional view of the locking assembly carried by the handle of FIG. 5 positioned in engagement with the mounting member attached to the item of cookware shown in FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

For ease of discussion and understanding, the following detailed description will refer to the removable handle in association with “cookware” or an “item of cookware” while illustrating aspects of the system in association with a pot. It should be appreciated that the pot is provided for purposes of illustration, and the removable handle disclosed herein can be used in association with any suitable cookware, including, but not limited to, a kettle, pot, pan, lid, etc. In addition, the removable handle can be used in association with any suitable vessel where it may be desirable to have a selectively removable handle.

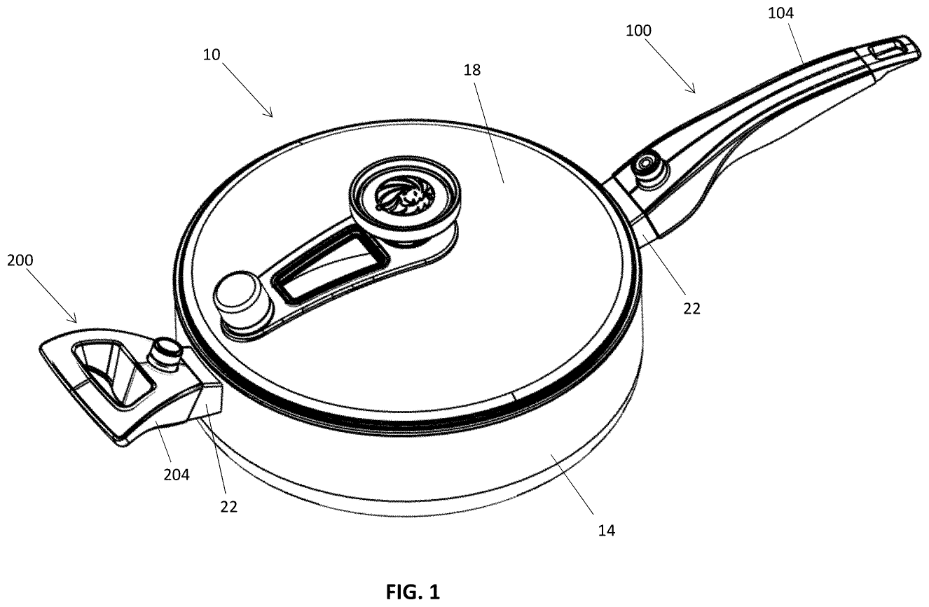

With reference to FIG. 1, an embodiment of an item of cookware 10, shown as a pot 10, is illustrated. The item of cookware 10 includes a base 14 that defines a cooking vessel. An optional lid 18 is configured to engage the base 14 and cover the cooking vessel. A plurality of mounting members 22 (or mounting portions 22) are coupled to the item of cookware 10. In the illustrated embodiment, the mounting members 22 are coupled to the base 14. However, in other embodiments the mounting members 22 can be positioned on or mounted to any suitable location of the item of cookware 10. The mounting members 22 can be coupled (or fastened) to the cookware 10 in any suitable manner of attachment, such as by weld, bolt, or any other suitable fastener. While the illustrated item of cookware 10 includes a plurality of mounting members 22, in other embodiments, the item of cookware 10 can include a single mounting member 22, at least one mounting member 22, or any suitable number of mounting members 22.

A first removable handle assembly 100 is engaged with one of the plurality of mounting members 22 (or a first mounting member 22). The first removable handle assembly 100 includes a first handle 104. The first handle 104 is shown as an elongated handle that, when engaged with the first mounting member 22 attached to the base 14, generally extends radially from the item of cookware 10. The elongated handle 104 has a shape to allow a user to grasp and move the attached item of cookware 10.

A second removable handle assembly 200 is engaged with another one of the plurality of mounting members 22 (or a second mounting member 22). The second removable handle assembly 200 includes a second handle 204, which is shown as a ring or looped handle. The looped handle 204 is another example of a shape that allows a user to grasp and move the attached item of cookware 10. While the illustrated item of cookware 10 includes one elongated handle 104 and one looped handle 204, in other embodiments the item of cookware 10 can include any number or shape of handles. For example, the item of cookware 10 can include one looped handle 204, a plurality of looped handles 204 (e.g., two looped handles 204, etc.), one or more elongated handles 104, a single elongated or looped handle 104, 204, a plurality of different length elongated handles 104, a plurality of different sized looped handles 204, and/or any suitable shaped or sized handle to facilitate user movement of the item of cookware 10.

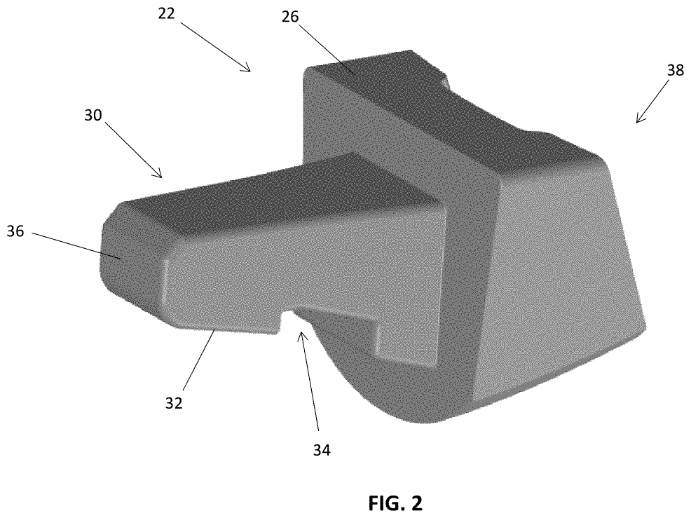

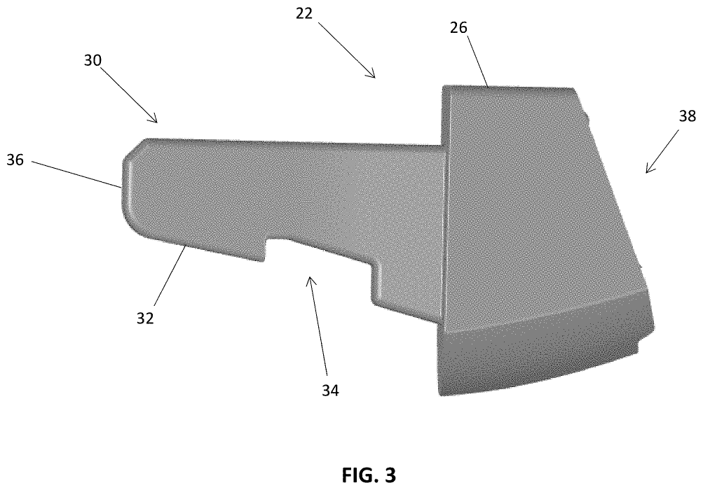

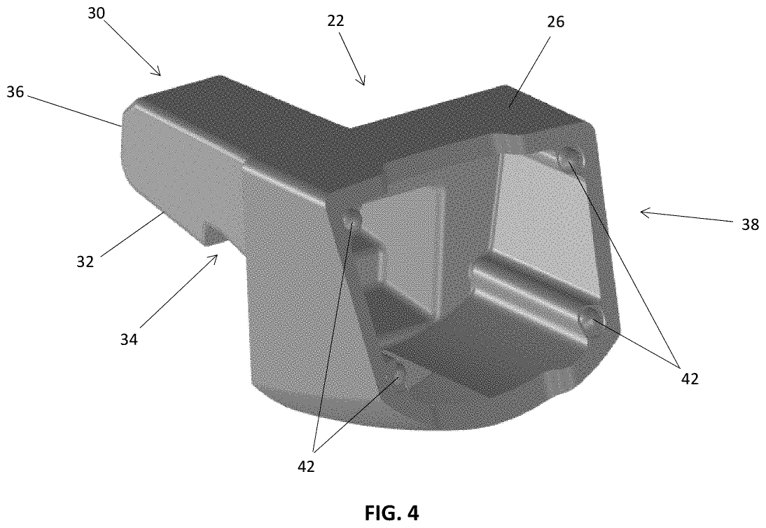

With reference now to FIGS. 2-4, the mounting member 22 is illustrated as detached from the item of cookware 10. The mounting member 22 includes a collar 26. A handle connection member 30 projects from a first side of the collar 26. The handle connection member 30 includes a sloped surface 32 and defines a channel 34. The sloped surface 32 is positioned between a tip 36 of the handle connection member 30 and the channel 34. The collar 26 also includes an item of cookware connection portion 38. The item of cookware connection portion 38 is on a side of the collar 26 opposite the handle connection member 30. With specific reference to FIG. 4, the item of cookware connection portion 38 includes a plurality of contact points 42 to facilitate fastening to the item of cookware 10. The contact points 42 are each illustrated as elongated passages that are configured to receive a fastener (e.g., a bolt, a screw, etc.) to facilitate attachment to the item of cookware 10. In other embodiments, the contact points 42 can be weld points, or any other suitable fastening assembly for attaching the mounting member 22 to the item of cookware 10.

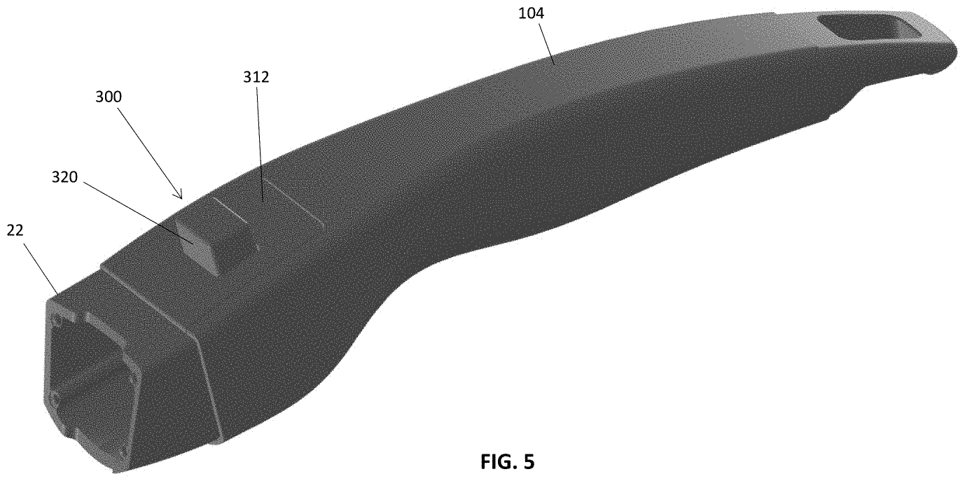

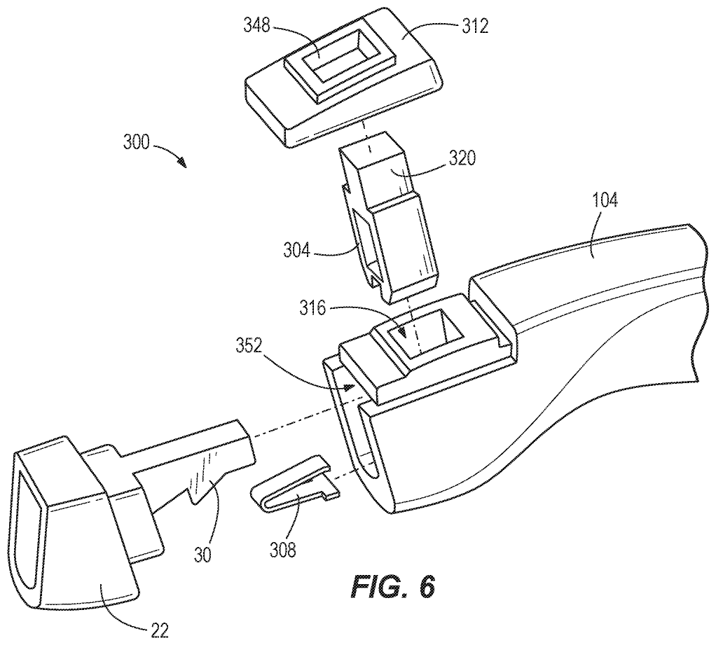

Referring now to FIGS. 5-6, a locking assembly 300 is illustrated in greater detail. The locking assembly 300 is shown in association with the first handle 104. More specifically, the first handle 104 carries the locking assembly 300. The locking assembly 300 is also configured to selectively engage the mounting member 22. The mounting member 22 is shown disengaged with the base 14 (shown in FIG. 1) for purposes of clarity. While illustrated in association with the first handle 104, it should be appreciated that the locking assembly 300 can also be used in association with the second handle 204. Accordingly the term “handle” can include the first handle 104 or the second handle 204.

With specific reference to FIG. 6, the locking assembly 300 includes a locking member 304, a biasing member 308, and a cover 312. The locking member 304 is slidably received within a slot 316 in the handle 104. The biasing member 308 (or spring 308 or flat spring 308 or U-shaped spring 308) is positioned at a base (or bottom) of the slot 316.

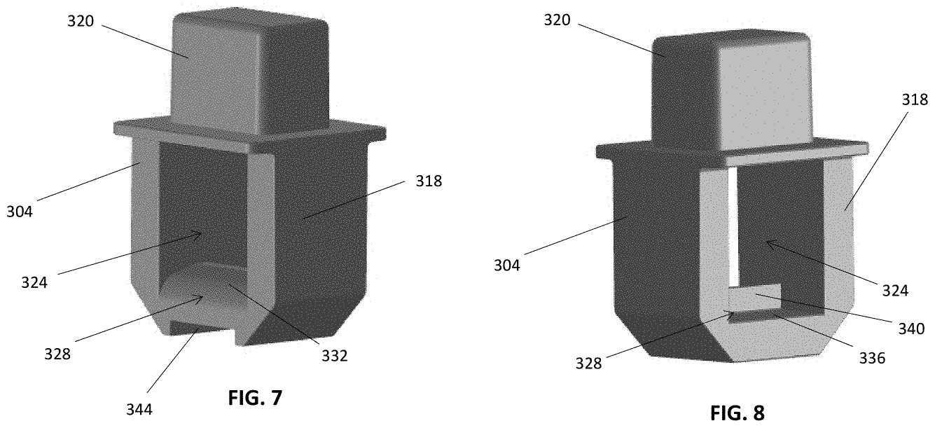

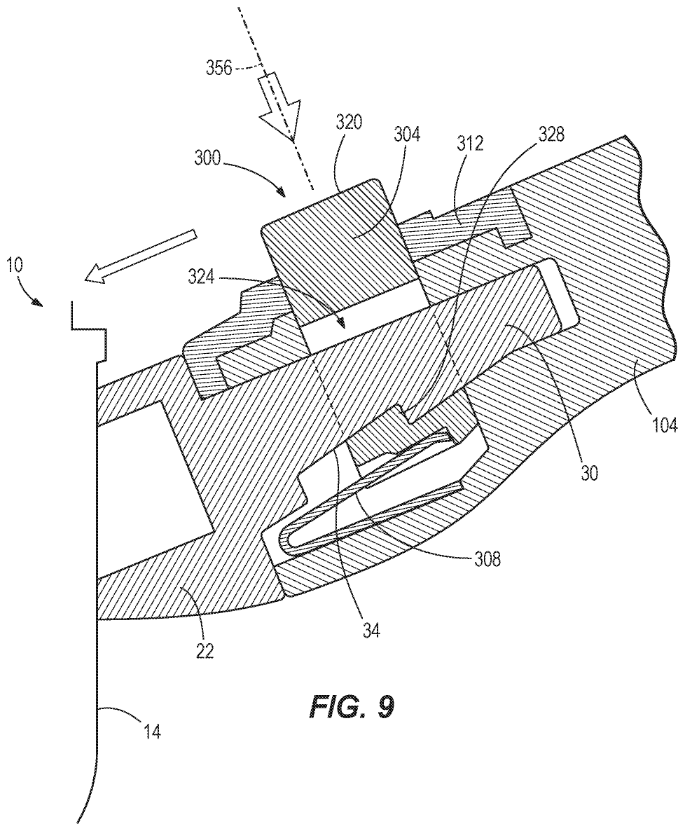

With reference to FIGS. 7-8, the locking member 304 includes a housing 318 that defines a button 320 (or used actuated projection 320). The housing 318 defines an aperture 324 (or central aperture 324) that extends entirely through the housing 318. A locking surface 328 is provided on one of the circumferential surfaces that define the aperture 324. The locking surface 328 includes a first surface portion 332 (shown in FIG. 7) and a second surface portion 336 (shown in FIG. 8). The first surface portion 332 is a curved (or arcuate) surface. In addition, the first surface portion 332 is offset from the second surface portion 336. Stated another way, the first surface portion 332 projects above the second surface portion 336 to form an edge surface 340 (see FIG. 8). As shown in FIG. 7, the housing 318 also includes a channel 344 positioned on an exterior surface opposite the button 320. The channel 344 is configured to receive a portion of the biasing member 308. Thus, the biasing member 308 applies a biasing force to the locking member 304 to facilitate selective slidable movement within the slot 316 in the handle 104.

With reference back to FIG. 6, when slidably received in the slot 316, the locking member 304 is retained in the slot 316 by the cover 312. The cover 312 includes an aperture 348 that is configured to receive the button 320. The cover 312 is configured to couple to the handle 104 (e.g., snap fit, etc.) to facilitate retention of the locking member 304 within the slot 316. The handle 104 also defines an opening 352 (or aperture 352) in an end of the handle. The opening 352 is configured to receive the handle connection member 30.

In operation, the mounting member 22 is coupled to the base 14 of the item of cookware 10. To attach the handle 104 to the mounting member 22, a user slides the handle 104 into engagement with the mounting member 22. More specifically, the user slides the handle 104 towards the mounting member 22. The handle connection member 30 is slidably received by the opening 352 of the handle 104. The handle connection member 30 is then slidably received by the aperture 324 of the locking member 304, such that the locking surface 328 is positioned into locking engagement with the channel 34 of the handle connection member 30. More specifically, the sloped surface 32 of the handle connection member 30 slides along the curved first surface portion 332. As it slides, the sloped surface 32 can apply a downward force sufficient to overcome the bias applied by the biasing member 308 to the locking member 304. Once the sloped surface 32 slides past the curved first surface portion 332, such that the sloped surface 32 is approximately vertically aligned with the second surface portion 336 and the channel 34 is approximately vertically aligned with the curved first surface portion 332, the sloped surface 32 no longer overcomes the bias, and the biasing member 308 “rebounds,” or applies a biasing force on the locking member 304. The biasing slides the locking member 304 along an axis 356 defined by the button 320 (see FIG. 10). This positions the locking surface 328 into engagement with the channel 34, locking the handle connection member 30 to the locking member 304. This facilitates engagement of the handle 104 to the base 14 of the item of cookware 10 by the mounting member 22.

With reference to FIG. 10, to detach the handle 104 from the mounting member 22, the user depresses the button 320. More specifically, the user applies a downward force on the button 320 (or depresses the button 320) along the axis 356 defined by the button 320. The downward force is sufficient to overcome the bias applied to the locking member 304 by the biasing member 308. The locking member 304 slides within the slot 316 towards the biasing member 308. As the locking member 304 slides, the locking surface 328 is disengaged from the channel 34 of the mounting member 22. This frees the handle connection member 30 to be removed from the handle 104. More specifically, the handle 104 is removed from the handle connection member 30, with the handle connection member 30 sliding out of the aperture 324 of the locking member 304, and sliding out of the opening 352 of the handle 104.

Various features and advantages of the invention are set forth herein and in the following claims.

What is claimed is:

1. A detachable handle assembly for an item of cookware, comprising:
a handle configured to removably engage a mounting member coupled to the item of cookware;
a locking assembly slidably received in a slot defined by the handle, the locking assembly including:
a housing defining an aperture and a button;
a biasing member configured to apply a biasing force on the housing; and
a locking surface positions on a circumferential surface that defines the aperture,
wherein the mounting member is configured to be received by the aperture and selectively engage the locking surface.

2. The detachable handle assembly of claim 1, wherein the mounting member defines a channel that is configured to engage the locking surface.

3. The detachable handle assembly of claim 1, wherein the locking surface includes a first surface portion offset from a second surface portion.

4. The detachable handle assembly of claim 3, wherein the first surface portion is vertically offset from the second surface portion by an edge surface.

5. The detachable handle assembly of claim 3, wherein the first surface portion is a curved surface.

6. The detachable handle assembly of claim 1, wherein the housing defines a channel that is configured to receive a portion of the biasing member.

7. The detachable handle assembly of claim 1, wherein the housing slides within the slot of the handle along an axis defined by the button.

8. The detachable handle assembly of claim 1, wherein:
the locking assembly is operable between a first position and a second position; and
the locking surface is configured to engage the mounting member in response to the locking assembly being in the first position.

9. The detachable handle assembly of claim 8, wherein in response to actuation of the push button along an axis defined by the button, the locking assembly slides within the slot defined by the handle and the locking surface is configured to disengage the mounting member.
